(19) United States
(12) Patent Application Publication
(10) Pub. No.: US 2009/0206690 A1
(43) Pub. Date: Aug. 20, 2009

(54) MOTOR UNIT

(75) Inventor: Hiroyuki SONOHARA, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano (JP)

(21) Appl. No.: 12/368,153

(22) Filed: Feb. 9, 2009

(30) Foreign Application Priority Data
Feb. 8, 2008 (JP) JP2008-28347

(51) Int. Cl. H02K 5/00

(52) U.S. Cl. 310/91

(57) ABSTRACT

A motor unit for use with a motor-driven device may include a motor main body, having a stator and a turning shaft protruding from the stator; and a mounting plate for installing the motor main body on the motor driven device to which driving power of the motor main body is transmitted. The mounting plate may be structured by cutting a metal plate, and the mounting plate may include a tabular base plate and a stator support The tabular base plate may have a connecting section for connection to the motor-driven device, and the stator support rises from the tabular base plate and may be fixed to the stator. An edge of the connecting section may be chamfered shaped

### CROSS REFERENCE TO RELATED APPLICATION

The present invention claims priority under 35 U.S.C. § 119 to Japanese Application No. 2008-28347 filed Feb. 8, 2008, the entire contents of which are incorporated herein by reference.

### FIELD OF THE INVENTION

The present invention relates to motor units, and more particularly to a motor unit including a mounting plate to fix a motor main body onto a motor-driven device using the motor as a driving unit.

Conventionally known is a motor unit to be mounted on a motor-driven device (such as an optical head device having an optical lens) using the motor as a driving unit This kind of motor unit includes a metal mounting plate with which the motor main body is fixed to the motor-driven device (For example, refer to Patent Document 1). As FIG. 2B of Patent Document 1 shows, the motor unit of this type is installed generally by connecting a base part of the mounting plate to a chassis of the motor driven device or equivalent.

### [Patent Document 1]

Japanese Unexamined Patent Application Publication No. 2000-139057

Unfortunately this mounting plate has burrs at a sheared section, since the mounting plate is made by press working of a metal plate. Therefore, the burrs make the motor unit installed have a tilt to the motor driven device and/or it impairs the accuracy of driving performance of a driving object connected to a carriage.

### SUMMARY OF THE INVENTION

In view of the problems described above, at least an embodiment of the present invention may provide a motor unit that suppresses a tilt of the motor unit itself due to the burrs and enhances the accuracy of driving performance of the driving device.

In order to solve the problems described above, at least an embodiment of the present invention provides as follows.

A motor unit according to at least an embodiment of the present invention includes: a motor main body, having a stator and a turning shaft protruding from the stator; and a mounting plate for installing the motor main body on a motor-driven device to which the driving power of the motor main body is transmitted; wherein the mounting plate is manufactured by cutting a metal plate, and the mounting plate includes a tabular base plate and a stator support, the tabular base plate having a connecting section for connection to the motor-driven device, and the stator support rising from the base plate and being fixed to the stator, and an edge of the connecting section is cut out or ground.

In the motor unit according to at least an embodiment of the present invention, the edge of the connecting section of the base plate of the mounting plate is cut out or ground, the connecting section being for connection to the motor-driven device. Eventually, burrs at the edge caused at the time of cutting the mounting plate are Removed. Therefore, the motor unit is installed without any tilt with respect to the motor-driven device due to the burrs caused in the connecting section, and the driving object can be driven with high accuracy.

In this case, the mounting plate may further include a turning shaft support rising from the base plate so as to be opposite to the stator support and to support a top end of the turning shaft.

According to this disposition, the motor unit can be fixed to the motor-driven device without any tilt with respect to the motor driven device even though the mounting plate is U-shaped in its cross section having the turning shaft support to support the top end of the turning shaft. Therefore, the driving object can be driven with high accuracy.

In this case, preferably, a side surface of the base plate and one of side surfaces of the stator support and the turning shaft support should constitute the connecting section for connection to the motor-driven device. Furthermore, it is also preferable that the side surface of the base plate and both the side surfaces of the stator support and the turning shaft support constitute the connecting section for connection to the motor-driven device.

Thus, when the motor unit is installed by using each one side surface of the base plate and either of the stator support and the turning shaft support as the connecting section for connection to the motor-driven device, and namely the motor unit is installed, being laid horizontally; the installation space of the motor unit can be reduced in a vertical direction. For this disposition, if used as a connecting section for connection to the motor-driven device are not only the side surface of the base plate but also either or both of the side surface of the stator support and the turning shaft support, the connecting section becomes either L-shaped or U-shaped so that the motor unit can be installed further stably. Furthermore, all the side surfaces such as the side surface of the base plate, which work as the connecting section, are cut out or ground, and therefore the motor unit is installed without any tilt due to the burrs caused by cutting.

In this case, a side surface of the plate may have a plurality of protrusions protruding in a horizontal direction of the base plate; the protrusions being each formed at distant positions; and the manufacturing process of cutting out or grinding the edge of the connecting section may be carried out at least for the protrusions.

When the side surface of the base plate has the protrusions protruding in the horizontal direction of the base plate, not all the side surface of the base plate but only the protrusions need to be cut out or ground. According to this disposition, the motor unit can be fixed to the motor-driven device without any tilt in the same way as described above. Furthermore, the area to be cut out or ground in the mounting plate becomes limited and this leads to a reduction in the production cost of the motor unit Preferably, the manufacturing process of cutting out or grinding the edge of the connecting section should be so carried out as to have a flat area left on the connecting section.

According to this disposition, the motor unit can be fixed by connecting the flat area to the motor-driven device (The mounting plate and the motor-driven device are connected via plane-to-plane contact), and the motor unit can be installed further stably.

### ADVANTAGEOUS EFFECT OF THE INVENTION

In the case of a motor unit according to at least an embodiment of the present invention, the cutting or grinding operation, carried out for the edge of the connecting section of the mounting plate to connect with the motor-driven device, removes the burrs of the connecting section, which came up at the time of the cut working of the mounting plate. Therefore, the motor unit has no chance to be installed with any tilt due to the burrs of the mounting plate, and the driving object can be driven with high accuracy.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1A, 1B, and 1C show the structure of a motor unit according to an embodiment of the present invention FIG. 1A is a top view of the motor unit in a longitudinal direction, FIG. 1B is a side view of the motor unit at the output side in a widthwise direction, and FIG 1C is a side view of the motor unit in a longitudinal direction (a partially cross-sectional view).

FIG. 2 is a magnified view of a motor main body of the motor unit shown in FIGS. 1A, 1B, and 1C.

FIGS. 3A and 3B are drawings for explaining the first embodiment according to the present embodiment FIG. 3A is an external view of the motor unit shown in FIGS. 1A, 1B, and 1C being mounted on a motor-driven device. FIG. 3B is a cross-sectional view taken from the line A-A in FIG. 3A.

FIGS. 4A and 4B are drawings for explaining the second embodiment and the third embodiment of the present invention, respectively.

FIG. 5 is a drawing for explaining the modification of the first through third embodiments shown in FIGS. 3A and 3B as well as FIGS. 4A and 4B.

FIG. 6 is a magnified cross-sectional view for explaining a shape of a chamfer manufactured at an edge of each side surface of the base plate, the turning shaft support and the stator support.

FIGS. 7A and 7B are an external view and a cross-sectional view, respectively, of the motor unit being mounted on the motor-driven device by using the bottom surface of the base plate as a connecting section to the motor-driven device.

### DETAILED DESCRIPTION

Embodiments of the present invention are described below with reference to the accompanying drawings.

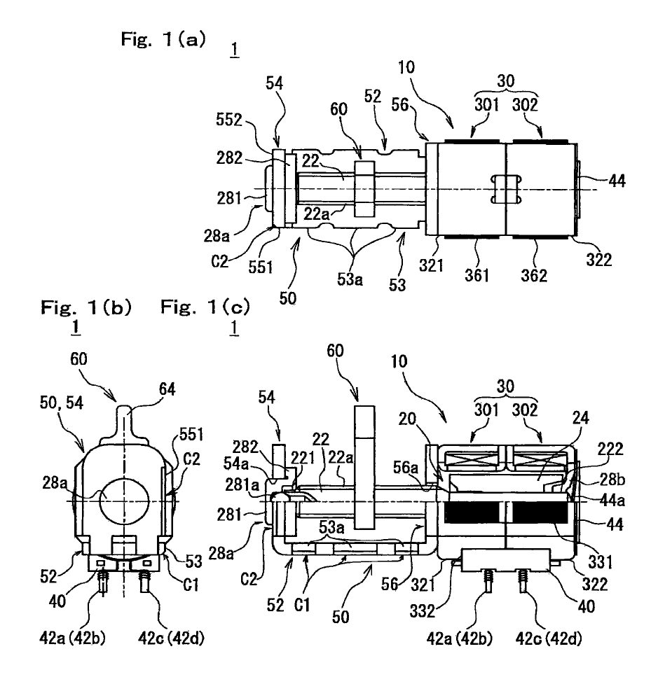

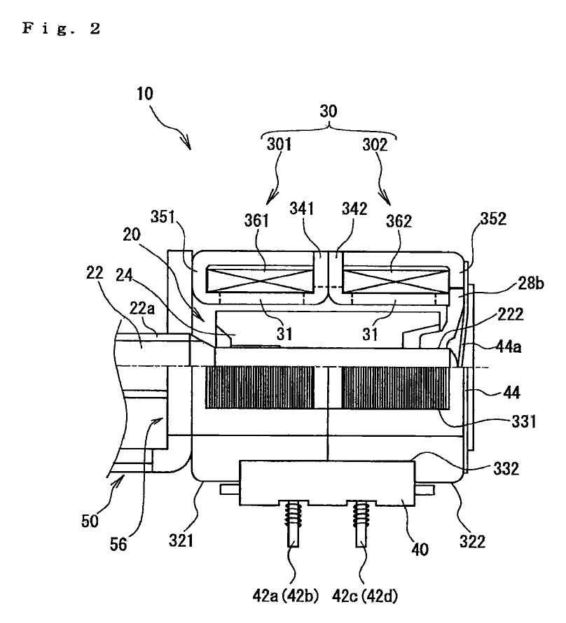

FIGS. 1 and 2 show the structure of a motor unit 1 according to an embodiment of the present invention. FIG. 1A is a top view of the motor unit 1 in a longitudinal direction, FIG. 1B is a side view of the motor unit 1 at the output side in a widthwise direction, and FIG. 1C is a side view of the motor unit 1 in a longitudinal direction (a partially cross-sectional view). FIG. 2 is a magnified view of a motor main body 10 shown in FIG. 1C.

The motor unit 1 according to the present embodiment includes the motor main body 10 and a mounting plate 50. The motor main body 10 has a turning shaft 22 and a stator 30. The mounting plate 50 has a turning shaft support 54 supporting an output side end of the turning shaft 22, and a stator support 56 placed at an opposite position to the tuning shaft support 54 and fixed to the stator 30.

The motor main body 10 is a so-called stepping motor having the turning shaft 22 and the stator 30. The turning shaft 22 protrudes from the stator 30 At an opposite end to the output side end of the turning shaft 22, a permanent magnet 24 is fixed with adhesive to the turning shaft 22, wherein the permanent magnet 24 includes an N-pole section and an S-pole section magnetized alternately in a circumferential direction Thus the turning shaft 22 and the permanent magnet 24 together constitute a rotor 20. Furthermore, a lead screw 22a is formed on a circumferential surface of the turning shaft 22 at its output side (i.e., the part protruding from the stator 30), (but no lead screw is formed at an output side end 221 of the turning shaft 22). The output side end 221 of the turning shaft 22 is supported by an output side bearing 28a that the mounting plate 50 holds. Meanwhile, an opposite end 222 to the output side end of the turning shaft is supported by an opposite end bearing 28b fixed to an outer stator core 352.

The stator 30 of the motor main body 10 includes a first stator assembly 301 and a second stator assembly 302 that are disposed side by side in an axial direction of the turning shaft 22 at an outer circumferential position facing the permanent magnet 24.

As shown in FIG. 2, the first stator assembly 301 and the second stator assembly 302 include inner stator cores 341 and 342, respectively; and also include outer stator cores 351 and 352, respectively. Driving coils 361 and 362 are wound for the inner stator cores 341 and 342, respectively, while the driving coils 361 and 362 are sandwiched between the inner stator cores 341 and 342 and the outer stator cores 351 and 352, respectively. In the present embodiment, the driving coils 361 and 362 are so-called bobbin-less coils that have no coil bobbin.

At each inner circumferential edge of the inner stator cores 341 and 342 as well as the outer stator cores 351 and 352, a plurality of pole teeth 31 rising along the axial direction are formed at regular intervals. On the inner circumferential side of the driving coils 361 and 362, the plurality of pole teeth 31 of the inner stator core 341 and the outer stator core 351 are so disposed as to intrude each other alternately, and the pole teeth 31 of the inner stator core 342 and the outer stator core 352 are also disposed in the same manner so as to intrude each other alternately. In the present embodiment therefore, the annulus driving coil 361 is positioned at an outer circumference of the pole teeth 31 of the inner stator core 341 of the first stator assembly 301 and the outer stator core 351. Since a thin insulating film (not shown) is formed on the entire surface of the driving coils 361 and 362 in at least an embodiment of the present invention to cover them, no short-circuiting occurs even without any coil bobbins. While tile driving coils 361 and 362 are disposed adjacent to the pole teeth 31, preferably the driving coils and the pole teeth are distant from each other or an insulating material is placed between the two elements for prevention of any short-circuiting by bringing the outer circumferential surface of the pole teeth 31 into direct contact with the inner circumferential surface of the driving coils 361 and 362.

Outer circumferential edges of the outer stator cores 351 and 352 are so bent as to cover the outer circumferential surfaces of the driving coils 361 and 362, respectively; working as motor cases. Hereinafter, the sections of the outer stator cores 351 and 352 covering the outer circumferential surfaces of the driving coils 361 and 362 are called a first motor case 321 and a second motor case 322, respectively. The first motor case 321 and the second motor case 322 are formed by draw-processing to be cylindrical.

Having prescribed dimensions, first cutout openings 331 are formed at both the sidewalls of the first motor case 321 and the second motor case 322. Thus, the motor unit 1 is formed to be namely oval. As FIGS. 1A to 1C as well as FIG. 2 clearly show, part of the driving coils 361 and 362 is exposed from the first cutout openings 331. Furthermore, having prescribed dimensions, a second cutout opening 332 is formed at another position (at a bottom wall section shown in FIGS. 1A to 1C as well as FIG. 2), which is different from the positions of the first cutout openings 331, in the first motor case 321 and the second motor case 322. Protruding from the second cutout opening 332, a terminal block 40 is fixed to the inner stator cores 341 and 342.

The terminal block 40 is fixed to outer circumferential edges of the inner stator cores 341 and 342, and it has terminal pins 42a through 42d for power supply. By means of insert-molding, press-fitting, or any other equivalent method, the terminal block 40 is fixed to the outer circumferential edges of the inner stator cores 341 and 342. Bound around the terminal pins 42a through 42d are wire terminals of the driving coils 361 and 362.

The outer stator core 352 includes the opposite end bearing 28b (radial bearing) being placed opposite to the output side, which is assembled by means of press-fitting, or any other equivalent method, and it supports the opposite end 222 to the output side end of the turning shaft 22, Moreover, the outer stator core 352 includes a biasing part 44 fixed by means of laser-welding, or any other equivalent method. The biasing part 44 has a biasing element 44a (leaf spring), which forces the turning shaft 22 toward the output side. Furthermore, the biasing part 44 also works as a member that prevents the opposite end bearing 28b from falling away.

The mounting plate 50 is formed to have a U-shape by bending both ends of a metal plate almost perpendicular, and it is manufactured by press-working (cutting). The mounting plate 50 is used for mounting the motor unit 1 onto a motor-driven device. The mounting plate 50 includes a tabular base plate 52 having a connecting section for connection with the motor-driven device, the turning shaft support 54 rising from the base plate 52, and the stator support 56.

The base plate 52 is a base part of the mounting plate 50, and it is shaped to be tabular and positioned almost parallel to the turning shaft 22. The length of the base plate 52 in the longitudinal direction is almost the same as that of a lead screw 22a of the tuning shaft 22, i.e., the stroke of an engaged component 60. A side surface 53 of the base plate 52 has a plurality of protrusions 53a protruding in a horizontal direction of the tabular plate, wherein the protrusions are each formed at distant positions. In other words, between neighboring two protrusions 53a, a concave part is formed to be concave in the horizontal direction of the tabular plate. In the present embodiment, one side surface 53 of the base plate 52 includes three protrusions 53a at three distant positions, each position having one protrusion.

The turning shaft support 54 is formed so as to vertically rise from an output side end of the base plate 52. Almost at its center, the turning shaft support 54 has a bearing assembly hole 54a, where the output side bearing 28a is fixed to support the output side end 221 of the tuning shaft 22. Specifically to describe, the output side bearing 28a is a pivot bearing that includes a main section 281 and a flange part 282, The main section 281 has a concave formed at its center, and a steel ball 281a is fitted in the concave to support the output side end 221 of the turning shaft 22 that is forced toward the output side by the biasing part 44. As shown in FIG. 1C, for preventing the total length of the motor unit 1 from becoming longer, the output side bearing 28a is fixed while having the flange part 282 protrude from the turning shaft support 54 toward the opposite end to the output side.

The stator support 56 is formed so as to vertically rise from an opposite side end to the output side of the base plate 52, and it faces the turning shaft support 54. Almost at its center, the stator support 56 has a through hole 56a that is slightly larger than the turning shaft 22. The turning shaft 22 goes through the through hole 56a of the mounting plate 50, and the stator support 56 is assembled onto the first motor case 321 (the outer stator core 351) by means of laser-welding, or any other equivalent method.

The mounting plate 50 is manufactured in the work step order outlined below, by using a progressive press machine. Specifically to describe, a first working process manufactures holes such as the bearing assembly hole 54a of the turning shaft support 54 and the through hole 56a of the stator support 56 in a thin metal plate of material. A second working process manufactures the thin metal plate to have an expansion shape of the mounting plate 50. A third working process carries out chamfering (cutting out or grinding), which is described separately, for edge parts as required. A fourth working process bends sections of the turning shaft support 54 and the stator support 56 to have a U-shape. Finally connected parts between workpieces are cut to finish a workpiece of the the mounting plate 50.

The mounting plate 50 manufactured through the working processes as described above has a plurality of cut or ground sections. Specifically, as shown in FIG. 1C, the three protrusions 53a manufactured at one side surface 53 of the base plate 52 (a lower side surface in FIG. 1A) have a chamfer C1 at their bottom side edges (bottom side edge lines of the base plate 52 at the side surface 53) in a longitudinal direction of the motor unit 1 Furthermore, a side surface 551 of the turning shaft support 54 (a lower side surface in FIG. 1A) has a chamfer C2 at its output side edge (an edge side line at the output side in the side surface 551) in a vertical direction of the motor unit 1. The chamfering processes of the chamfers remove burrs caused by perforation in the first working process at the side surface 53 of the base plate 52 and the side surface 551 of the turning shaft support 54. Effects of the chamfering processes on the mounting plate 50 are described later separately.

The engaged component 60 with connecting portion 64 is engaged with the turning shaft 22. The engaged component 60 is made of resin, and it is also called a carriage. Formed almost at a center of the engaged component 60 is an engaged bore (not shown) that is manufactured so as to become enabled to engage with the lead screw 22a of the turning shaft 22 (with a female screw formed on it).

When the lead screw 22a of the turning shaft 22 is engaged with the engaged bore that is not shown, the engaged component 60 is supported by the turning shaft 22. Meanwhile, the engaged component 60 is connected to a driving object so that it does not rotate together with the turning shaft 22. As a result, according to the rotation of the turning shaft 22, the engaged component 60 moves back and forth in the axial direction of the turning shaft 22 and therefore the driving object connected to the engaged component 60 also moves back and forth along a specified path in parallel with the turning shaft 22.

Explained below are effects of the mounting plate 50 included in the motor unit 1 constructed as described above, the chamfering processes having been implemented on the mounting plate 50.

### First Embodiment

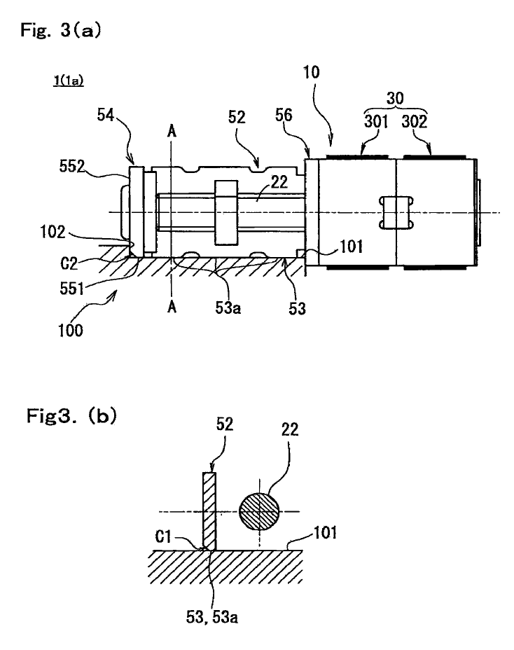

FIG. 3A shows a condition where a motor unit la according to a first embodiment is mounted on a motor-driven device. FIG. 3B is a cross-sectional view taken from the line A-A in FIG. 3A. As FIGS. 3A and 3B show, the motor unit 1a is fixed by connecting the side surface 53 of the base plate 52 to a mounting surface 101 of a motor mounting section 100 in the motor-driven device. In other words, the side surface 53 of the base plate 52 is a connecting section.

In the present embodiment, the three protrusions 53a in the side surface 53 of the base plate 52, which work as a section for connection with the motor-driven device, are chamfered to have a chamfer C1 as described above so that burrs caused by press-working (cutting) at the protrusions 53a are removed. Therefore, even if the motor unit 1a is horizontally mounted onto the mounting surface 101 of the motor mounting section 100 in the motor-driven device, i.e., by using the side surface 53 of the base plate 52 as a connecting section; the motor unit 1a is installed without any tilt due to the burrs caused at the side surface 53 of the base plate 52, the tilt being with respect to the mounting surface 101 of the motor mounting section 100 in the motor-driven device.

The motor mounting section 100 of the motor-driven device includes a step 102. The motor unit la is fixed by connecting the side surface 551 of the turning shaft support 54 to the mounting surface 101 of the motor mounting section 100 and also by connecting the output side end surface 552 of the turning shaft support 54 to the step 102.

In the present embodiment, the stator support 56 is not connected to the mounting surface 101 of the motor mounting section 100 in the motor driven-device, and therefore part of the stator 30 of the motor main body 10 is positioned to be lower than the mounting surface 101. This arrangement can reduce the installation space of the motor unit la in a vertical direction in FIG. 3A.

Thus, connected to the motor mounting section 100 is not only the side surface 53 of the base plate 52 but also the side surface 551 of the turning shaft support 54 as well as the output side end surface 552, and this arrangement stabilizes the mounting condition of the motor unit 1a. In other words, if only the side surface 53 of the base plate 52 is connected to the mounting surface 101, a section connecting the motor unit 1a and the motor-driven device includes only a narrow thickness part of the side surface 53 of the base plate 52 (a slender and narrow linear section). Therefore, the motor unit 1a cannot be stabilized and may be tilted in such a case. On the other hand, if the side surface 551 of the tuning shaft support 54 is also included in the section, for connecting the motor-driven device, in addition to the side surface 53 of the base plate 52, the section for connecting the motor unit 1a and the motor-driven device becomes L-shaped. As a result, the motor unit 1a can stably be fixed to the motor-driven device, and this arrangement prevents any tilt of the motor unit 1 with respect to the mounting surface 101. Moreover, when the output side end surface 552 of the turning shaft support 54 is connected to the step 102 as shown in the present embodiment, any movement of the motor unit 1a in the axial direction of the turning shaft 22 is restricted and installation condition of the motor unit 1a can be further improved.

In the present embodiment, the output side edge in the side surface 551 of the turning shaft support 54 is chamfered to have a chamfer C2 as described above so that burns caused by press-working (cutting) are removed Therefore, even if the motor unit 1a is mounted by using the side surface 551 and the output side end surface 552 of the turning shaft support 54 as sections for connection with the motor mounting section 100, the motor unit 1a is installed without any tilt due to the burrs caused at the side surface 551 of the turning shaft support 54, the tilt being with respect to the mounting surface 101 of the motor mounting section 100 in the motor-driven device.

Thus, in the present embodiment, the edges of the side surface 53 of the base plate 52 and the side surface 551 of the turning shaft support 54, which work as sections for connection with the motor-driven device, are chamfered. Therefore, the motor unit 1a being installed is not tilted due to burrs caused by press-working. As a result, this arrangement can greatly improve motion accuracy of the driving object.

### Second Embodiment

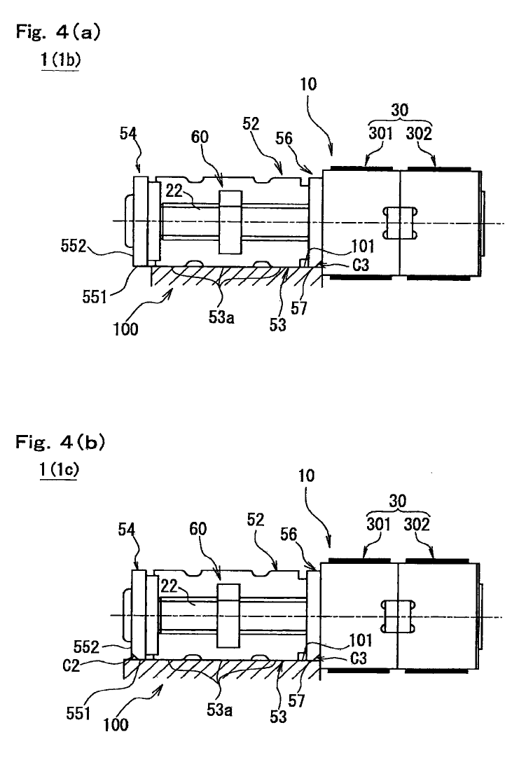

In the first embodiment shown in FIGS. 3A and 3B, the side surface 53 of the base plate 52 and the side surface 551 of the turning shaft support 54 work as sections for connection with the motor-driven device. Alternatively, as shown in FIG. 4A, a motor unit 1b may be so constructed as to use a side surface 57 of the stator support 56 (a lower side surface in FIG. 4A) in addition to the side surface 53 of the base plate 52 for connection with the motor-driven device. According to this arrangement, the section for connecting the motor unit 1b to the mounting surface 101 of the motor mounting section 100 in the motor-driven device becomes L-shaped in the same manner as described for the first embodiment so that the motor unit 1b can stably be fixed. In this case, for avoiding any tilt of the motor unit 1b being installed, it is required to chamfer an opposite side edge to the output side in the side surface 57 of the stator support 56 (an edge side line at the opposite side to the output side in the side surface 57) to have a chamfer (c3) for removing burrs.

### Third Embodiment

In the first and second embodiments, a combination of the side surface 53 of the base plate 52 and the side surface 551 of the turning shaft support 54, or another combination of the side surface 53 of the base plate 52 and the side surface 57 of the stator support 56 works as a section for connection with the motor-driven device, while the connecting section being L-shaped. Alternatively, as shown in FIG. 4B, a motor unit 1c may be so constructed as to use all the side surface 53 of the base plate 52, the side surface 551 of the turning shaft support 54, and the side surface 57 of the stator support 56 for connection with the motor-driven device. According to this arrangement, the section for connecting the motor unit 1c to the mounting surface 101 of the motor mounting section 100 in the motor-driven device becomes U-shaped so that the motor unit 1c can furthermore stably be fixed. It is required to carry out cutting out or grinding each corresponding edge of the side surface 53 of the base plate 52, the side surface 551 of the turning shaft support 54, and the side surface 57 of the stator support 56 in the same manner as described above to remove the burrs.

(Modification of the First through Third Embodiments)

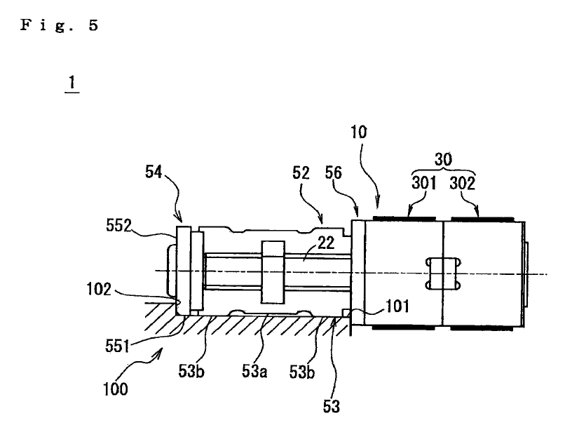

In the first through third embodiments, the side surface 53 of the base plate 52 includes the three protrusions 53a, and all the three protrusions 53a are formed so as to connect with the mounting surface 101 of the motor mounting section 100. However, in the process of cutting the workpiece of the mounting plate 50 for separation as described above, preferably a protrusion 53a positioned between other two protrusions in all three protrusions should be cut so as not to protrude in a horizontal direction of the base plate 52 (Refer to FIG. 5). When the three protrusions 53a are so formed as to protrude in the horizontal direction of the base plate 52 as described in the first through third embodiments, all the protrusions 53a connecting with the motor-driven device need to be chamfered. Meanwhile, if the protrusion 53a positioned between the other two protrusions (the parts referred with a reference numeral 53b in FIG. 5) on the side surface 53 of the base plate 52 is indented, being compared with the other two protrusions, in the horizontal direction of the tabular plate, only the protrusions protruding in the horizontal direction of the tabular plate (the parts referred with the reference numeral 53b in FIG. 5) need to have the chamfer C1 and the other part may have burrs. Therefore, if the protrusion 53a being cut in the end is so cut as not to connect with the motor-driven device, the area that requires chamfering can be reduced and only the two protrusions 53b, positioned separately and sandwiching the protrusion 53a, need to become parallel. As a result, this arrangement can further stabilize the installation and reduce the production cost of the motor unit 1.

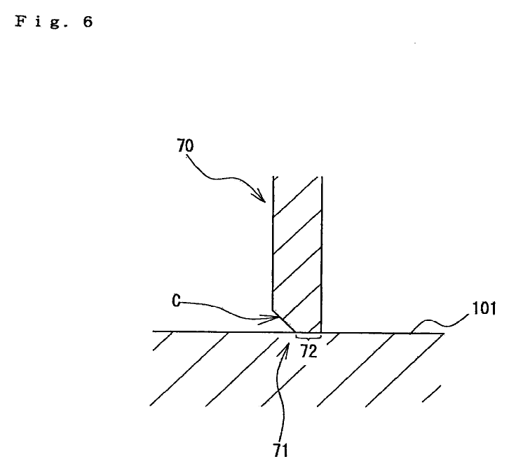

In the embodiments described above, the chamfers on the side surfaces 53, 551, and 57 of the base plate 52, the tuning shaft support 54 and the stator support 56 are so manufactured as to have each corresponding flat area left on the side surfaces. FIG. 6 is a magnified cross-sectional view for concretely describing a shape of an edge section (a connecting section) after cutting out or grinding the section. As FIG. 6 shows, the side surfaces 53, 551, and 57 (to be referred to comprehensively as a reference numeral 71 in FIG. 6) of the base plate 52, the turning shaft support 54 and the stator support 56 (to be referred to comprehensively as a reference numeral 70 in FIG. 6) have a flat area 72 left on the surfaces, while including the chamfers C1 through C3 (to be referred to comprehensively as a reference symbol ‘C’ in FIG. 6) only at the positions having burrs. When the flat area 72 is left as shown in the figure, the motor unit 1 can be installed stably on the mounting surface 101 even having the chamfer. Therefore, for securing the connecting section between the mounting plate 50 and the mounting surface 101 as wide as possible, it is preferable that the size of the chamfer is minimized as long as the burrs are fully removed so as to leave the flat area 72 maximized.

According to the motor unit 1 of the first through third embodiments, when the motor main body 10 is mounted on the motor mounting section 100 in the motor-driven device, the side surfaces of the mounting plate 50 (the side surface 53 of the base plate 52, the side surface 551 of the tuning shaft support 54, and the side surface 57 of the stator support 56) connect with the mounting surface 101 and the chamfers (C1 through C3) manufactured on these side surfaces remove the burrs caused at the time of press-working (cutting) the mounting plate 50. Therefore, even when the motor unit 1 is installed, being laid horizontally to downsize the installation space for the motor unit 1, on the mounting surface 101 of the motor-driven device, the motor unit 1 is not tilted due to the burrs so that the driving object can be driven with high accuracy.

In the case where the mounting plate 50 includes the turning shaft support 54 for supporting the output side end 221 of the tuning shaft 22, there is not such a problem that the burrs caused at the connecting section of the mounting plate 50 tilt the motor unit 1 with respect to the motor-driven device so that the output side end 221 of the turning shaft 22, being displaced from its correct position, is inappropriately supported and the turning shaft 22 becomes bent, such a problem being possibly seen when the output side end 221 of the turning shaft 22 is supported by the motor-driven device. Furthermore, since the burrs of the connecting section of the mounting plate 50 are already removed, the motor unit 1 does not tilt with respect to the motor-driven device even though the mounting plate 50 having the turning shaft support 54 is formed to be U-shaped in its cross section.

Furthermore, not only the side surface 53 of the base plate 52, but also either or both of the side surface 551 of the turning shaft support 54 and the side surface 57 of the stator support 56 connect with the mounting surface 101 of the motor-driven device (i.e., the section connecting with the motor-driven device is either L-shaped or U-shaped) to install the motor unit 1. Therefore, the motor unit 1 is installed further stably.

As shown in FIG. 5, when the protrusions 53b protrude in the horizontal direction of the tabular plate further than the protrusion 53a being indented in the middle, only the protrusions 53b need to be chamfered (C1). Thus, the area to be chamfered in the mounting plate 50 becomes limited so that the production cost of the motor unit 1 can be reduced.

The chamfer ‘C’ (C1 through C3) is so manufactured as to have a flat area 72 left on its corresponding side surface. Therefore, the motor unit 1 can be fixed by connecting the flat area 72 to the motor-driven device, and the motor unit 1 can be installed further stably.

The embodiments described above are examples of preferred embodiments in accordance with the present invention, but the present invention is not limited to the above embodiments and various variations may be made without changing the concept of the present invention.

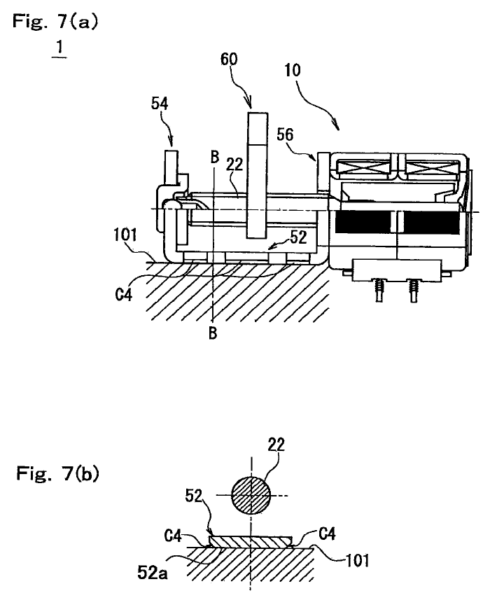

In the first through third embodiments described above, connected to the motor-driven device are the side surface 53 of the base plate 52 and at least one of the side surface 551 of the turning shaft support 54 and the side surface 57 of the stator support 56. Namely, in the embodiments, the motor unit 1 is installed, being laid horizontally. However, the technical concept of the present invention can also be used for other methods of installation. For example, the technical concept of the present invention can be applied to a case shown in FIGS. 7A and 7B where a bottom surface 52a of the base plate 52 of the mounting plate 50 connects with the motor-driven device. In this case, as shown in the figures, edges of the bottom surface 52a of the base plate 52 working as a connecting section need to have a chamfer C4, which is positioned at both the edges of the bottom surface 52a as shown in FIG. 7B. FIG. 7B is a cross-sectional view taken from the line B-B in FIG. 7A.

In the embodiments described above, the motor main body 10 is described as a stepping motor. However, the motor main body 10 can also be a DC motor (either a motor equipped with brush or a brushless motor). Furthermore, it is described that the mounting plate 50 includes the turning shaft support 54 and the stator support 56, which rise from both ends of the base plate 52, and the base plate 52 itself. However, the mounting plate 50 can be L-shaped in its cross section, not including the turning shaft support 54.

In the embodiments described above, only each one side of every two side surfaces of the mounting plate 50, such as the side surface 53 of the base plate 52, is chamfered. However, even when both the side surfaces are chamfered, the same effect can be obtained as it is in the embodiments described above.

In the embodiments described above, the burns at the connecting section for connection with the motor-driven device are removed by chamfering. However, the burrs may be removed by any other manufacturing process, e.g., cutting out or grinding such as barrel-polishing. Furthermore, the burrs may be removed or deformed in a chamfered shape by press working process, push working process or the like so as to form the edge of the connecting section to a chamfered shape.

Furthermore, though the mounting plate 50 is described to be manufactured by using a progressive press machine, such a manufacturing process is just an example and any other manufacturing process may be applied depending on the shape and other condition of the mounting plate 50.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather tan the foregoing description, and all changes which come within the meaning and range of equivalency of the claims are therefore intended to be embraced therein.

What is claimed is:

1. A motor unit for use with a motor-driven device comprising:
a motor main body, having a stator and a turning shaft protruding from the stator; and
a mounting plate for installing the motor main body on the motor-driven device to which driving power of the motor main body is transmitted;
wherein the mounting plate is structured by cutting a metal plate, and the mounting plate includes a tabular base plate and a stator support, the tabular base plate having a connecting section for connection to the motor-driven device, and the stator support rises from the tabular base plate and is fixed to the stator; and
an edge of the connecting section is chamfered shaped.

2. The motor unit according to claim 1:
wherein the mounting plate further includes a turning shaft support rising from the tabular base plate so as to be opposite to the stator support and to support an end of the tuning shaft.

3. The motor unit according to claim 2:
wherein a side surface of the tabular base plate and one of side surfaces of the stator support and the turning shaft support constitute the connecting section for connection to the motor-driven device.

4. The motor unit according to claim 2:
wherein a side surface of the tabular base plate and both the side surfaces of the stator support and the turning shaft support constitute the connecting section for connection to the motor-driven device.

5. The motor unit according to claim 1:
wherein a side surface of the tabular base plate has a plurality of protrusions protruding in a horizontal direction of the tabular base plate; the plurality of protrusions being each formed. at distant positions; and
the plurality of protrusions are chamfered shaped.

6. The motor unit according to claim 1:
wherein a manufacturing process of cutting out or grinding the edge of the connecting section is carried out so as to have a flat area left on the connecting section.

7. The motor unit according to claim 3:
wherein the side surface of the tabular base plate has a plurality of protrusions protruding in a horizontal direction of the tabular base plate; the plurality of protrusions being each formed at distant positions; and
the plurality of protrusions are chamfered shaped.

8. The motor unit according to claim 4:
wherein the side surface of the tabular base plate has a plurality of protrusions protruding in a horizontal direction of the tabular base plate; the plurality of protrusions being each formed at distant positions; and
the plurality of protrusions are chamfered shaped.
